(19) United States
(12) Patent Application Publication
(10) Pub. No.: US 2026/0233599 A1
(43) Pub. Date: Aug. 13, 2026

(54) SHAPE MEMORY ALLOY CONTROLLED AIRFLOW CONTROL DEVICES

(71) Applicant: Ford Global Technologies, LLC, Dearborn, MI (US)

(72) Inventors: Keith WESTON, Canton, MI (US); Lorne FORSYTHE, Wind Lake, WI (US); Alex ALLMANDINGER, Ferndale, MI (US); Trenton Lee MCMILLION, Roseville, MI (US); Thomas Joseph CICCONE, Plymouth, MI (US); Luma AL-TAMIMI, Windsor (CA)

(21) Appl. No.: 19/049,311

(22) Filed: Feb. 10, 2025

(51) Int. Cl. B60K 11/08

(52) U.S. Cl. CPC B60K 11/085; B60Y 2410/136

(57) ABSTRACT

An airflow control system for a vehicle may include an airflow control component configured to be repositioned to control a flow of air generated by motion of the vehicle, a vehicle substrate, and a component actuator comprising a shape memory alloy portion. The component actuator may be operably coupled to the vehicle substrate and the airflow control component to actuate automatically to reposition the airflow control component responsive to a temperature of the shape memory alloy portion reaching an activation temperature of a shape memory alloy material forming the shape memory alloy portion. The shape memory alloy portion may be passively exposed to temperature changes of a heat generating component of the vehicle, the temperature changes of the heat generating component of the vehicle being based on an operating state of the vehicle.

### TECHNICAL FIELD

Example embodiments generally relate to airflow control in and around vehicles and, more particularly, relate to controllable aerodynamic devices for which the control is based on passive exposure of shape memory alloy (SMA) material to heat generated by a vehicle component.

### BACKGROUND

Vehicles, and especially high performance vehicles, often employ airflow control devices such as aerodynamic devices that are designed to enhance aerodynamic performance. These aerodynamic devices and other airflow control devices are often static. The static positioning of aerodynamic devices provides increased downforce (decreasing lift) during turns, which generally enhances handling and stability. Additionally, setting aerodynamic balance (i.e., the location of the center of pressures or centroid of the aerodynamic force) is also generally limited to being adjusted before driving. However, the optimal aerodynamic balance is different for different cornering radii, vehicle weight, and road conditions.

Because airflow control devices are often static, they may provide enhanced performance over only a limited set of vehicle conditions. As such, these static airflow control devices may be designed to be set at positions that provide increases in average performance.

More recently, remotely operable airflow control devices have been produced that can be repositioned responsive to an electric control signal, and therefore introduce a dynamic aspect to the positioning of airflow control devices. However, the provision of electronic control generally requires additional wiring, electric motors, and other complication that would, in some cases, be preferable to omit. Thus, it may be desirable to develop airflow control devices, including aerodynamic devices and smart heat rejection devices, that addresses some of the shortcomings discussed above by being automatically operably under the control of shape memory alloys (SMAs) that operate whenever specific temperature thresholds are reached. Moreover, in the example of vent hoods, including such airflow control devices may enable the elimination of otherwise removable rain trays, thereby further increasing efficiency and customer satisfaction.

### BRIEF SUMMARY OF SOME EXAMPLES

In accordance with an example embodiment, an airflow control system for a vehicle may be provided. The airflow control system may include an airflow control component configured to be repositioned to control a flow of air generated by motion of the vehicle, a vehicle substrate, and a component actuator comprising a shape memory alloy portion. The component actuator may be operably coupled to the vehicle substrate and the airflow control component to actuate automatically to reposition the airflow control component responsive to a temperature of the shape memory alloy portion reaching an activation temperature of a shape memory alloy material forming the shape memory alloy portion. The shape memory alloy portion may be passively exposed to temperature changes of a heat generating component of the vehicle, the temperature changes of the heat generating component of the vehicle being based on an operating state of the vehicle.

In another example embodiment, a component actuator configured to actuate an airflow control component repositionable to control a flow of air generated by motion of a vehicle may be provided. The component actuator may include a shape memory alloy portion passively exposed to temperature changes of a heat generating component of the vehicle. The temperature changes of the heat generating component of the vehicle may be based on an operating state of the vehicle. The component actuator may be operably coupled to a vehicle substrate and an airflow control component to actuate automatically to reposition the airflow control component responsive to a temperature of the shape memory alloy portion reaching an activation temperature of a shape memory alloy material forming the shape memory alloy portion.

### BRIEF DESCRIPTION OF THE SEVERAL VIEWS OF THE DRAWING(S)

Having thus described the invention in general terms, reference will now be made to the accompanying drawings, which are not necessarily drawn to scale, and wherein:

FIG. 1 illustrates a block diagram of a vehicle control system in accordance with an example embodiment;

FIG. 2 illustrates a plot of temperature versus percent martensitic phase to demonstrate how a shape memory alloy material may change phases in accordance with an example embodiment;

FIG. 3 illustrates a partial cross section view of a hood having a hood vent assembly in accordance with an example embodiment;

FIG. 4 illustrates a cross section of a region surrounding an air passage blocked by a flap in accordance with an example embodiment;

FIG. 5 illustrates an unblocking of the air passage by movement of the flap via a first shape memory alloy portion being actuated in accordance with an example embodiment;

FIG. 6 illustrates a cross section of a region surrounding an air passage blocked by a flap in accordance with an example embodiment;

FIG. 7 illustrates an unblocking of the air passage by movement of the flap via a second shape memory alloy portion being actuated in accordance with an example embodiment;

FIG. 8 illustrates a block diagram of a shape memory alloy portion that is operably coupled to a mechanical linkage to move multiple flaps or louvers in accordance with an example embodiment;

FIG. 9 illustrates the provision of a gradient in temperature due to distance from the heat source as a potential trigger for different approaches to activation of the shape memory alloy portion at different temperatures in accordance with an example embodiment;

FIG. 10 illustrates a cross section view of an airfoil whose shape may be changed using shape memory alloy material in accordance with an example embodiment; and

FIG. 11 illustrates a block diagram of a fluid system that may employ a heat extractor to actuate a remotely located shape memory alloy portion in accordance with an example embodiment.

### DETAILED DESCRIPTION

Some example embodiments now will be described more fully hereinafter with reference to the accompanying drawings, in which some, but not all example embodiments are shown. Indeed, the examples described and pictured herein should not be construed as being limiting as to the scope, applicability or configuration of the present disclosure. Rather, these example embodiments are provided so that this disclosure will satisfy applicable requirements. Like reference numerals refer to like elements throughout. Furthermore, as used herein, the term “or” is to be interpreted as a logical operator that results in true whenever one or more of its operands are true. As used herein, operable coupling should be understood to relate to direct or indirect connection that, in either case, enables functional interconnection of components that are operably coupled to each other.

Additionally, as used herein, terminology such as “about,” “approximately” and “substantially,” when used to refer to variability of parameters, should be understood to be definite approximations that account for variations in measurements that cannot be, or as one of skill in the art would appreciate, normally are not, measured precisely. Thus, for example, a parameter that is “about,” “approximately” or “substantially” a given value or a given characteristic should be understood to be sufficiently close to the given value or given characteristic such that performance of the object or product to which the parameter applies, from the perspective of one with ordinary skill in the art, is the same as though the object or product had precisely the given value or characteristic.

Some example embodiments described herein may address the issues described above. In this regard, for example, some example embodiments may provide a dynamic and automatically operable system for airflow control (e.g., aerodynamic control and heat removal control) that includes airflow control components that are capable of being repositioned (including while driving to optimize drag, lift and other aerodynamic properties across various specific vehicle conditions including heat removal capacity) when certain temperature thresholds are reached via the operably coupling of shape memory alloy (SMA) in airflow control component actuators. Moreover, unlike other systems that may include SMAs, and which heat the SMA by the application of electrical current, some example embodiments may primarily rely on strategic and passive exposure to operational heat generation of the vehicle in order to actuate the airflow control component actuators. The passive exposure to heat generation discussed herein means that the heat that is generated, and experienced by the component actuator, is not purposely generated by the operator of the vehicle or any controller of the vehicle, but is instead generated and present based on vehicle operation without any direct control for heat application being provided. Optimizing airflow control device positions for instantaneously experienced conditions and situations can yield benefits in both customer confidence and vehicle capability with less compromise. As a result, efficiency, vehicle performance and driver satisfaction may also be enhanced.

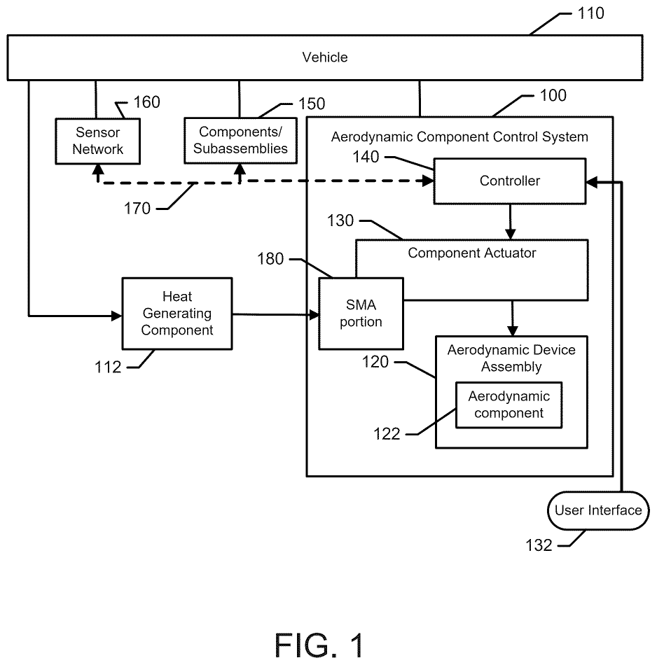

FIG. 1 illustrates a block diagram of an aerodynamic component control system 100 of an example embodiment. The components of the aerodynamic component control system 100 may be incorporated into a vehicle 110 (e.g., via being operably coupled to a chassis of the vehicle 110 and/or electronic control systems of the vehicle 110). In some cases, the chassis may include or be defined by a frame. The frame may additionally be formed of one or more cast, riveted, or welded metal subframes or may be a unibody construction. Of note, although the components of FIG. 1 may be operably coupled to the vehicle 110 and to each other, it should be appreciated that such connection may be either direct or indirect. Moreover, some of the components of the aerodynamic component control system 100 may be connected to the vehicle 110 via intermediate connections to other components either of the chassis or of other electronic and/or mechanical systems or components.

The vehicle 110 may include one or more instances of a heat generating component 112, which generates heat based on an operating state of the vehicle 110. In this regard, the heat generating component 112 should be understood to be a component of the vehicle 110 that generates heat whenever the vehicle 110 is on, running or otherwise operating, and therefore typically stops generating heat whenever the vehicle 110 is off, shutdown, or otherwise not operating. In other words, the heat generating component 112 is not a component that only generates heat responsive to the provision of an electric current designated specifically by the operator or a controller to generate heat, but is instead a component that naturally generates heat whenever the vehicle 110 is operational in a given operating state (which may include a charging state for charging of a battery of the vehicle 110 in some cases). Some examples of the heat generating component 112 may therefore include an engine of the vehicle 110 (e.g., an internal combustion engine (ICE)), an electric motor that propels the vehicle 110 (e.g., in the case of a battery powered electric vehicle (BEV) or hybrid vehicle), an exhaust system component, a coolant system of the vehicle 110 (e.g., that removes heat to cool another component of the vehicle 110), a brake system component, a battery of the vehicle 110, and/or the like.

The aerodynamic component control system 100 may include an aerodynamic device assembly 120 that may include one or more instances of an aerodynamic component 122 (e.g., a wing, strake, vent, airfoil, air guide, or the like) that are movable responsive to control initiated by the aerodynamic component control system 100 while the vehicle 110 is in operation and, in many cases also in motion. Notably, the aerodynamic device assembly 120 is an example of an airflow control device assembly more generally, and the aerodynamic component 122 is an example of an airflow control component more generally. Thus, the aerodynamic component control system 100 should also be more generally understood to be an example of an airflow control device control system. Moreover, when airflow control devices of example embodiments are employed for heat removal, such devices effectively become smart heat rejection devices that are automatically responsive to temperature changes.

In its simplest form, the aerodynamic device assembly 120 may include a single instance of the aerodynamic component 122 (e.g., a rear wing, a vent of a vent hood, a fender vent, a battery vent, a dive plane, a spoiler, a gurney flap, a splitter wicker, a grill shutter, etc.) that can be repositioned to change the state or aerodynamic properties (e.g., open/closed position, angle of attack, etc.) of the aerodynamic component 122. Changes between the open and closed position (e.g., deployed state and retracted state), as well as changes to the angle of attack or other aerodynamic properties, may all be considered to be state changes for the aerodynamic device assembly 120. The aerodynamic component control system 100 may include programming and programmatically controlled physical structures that enable the initiation of changes to the state of the aerodynamic device assembly 120 based on various conditions or information pertaining to vehicle operational status, and may be augmented in some cases also based on driver or operator control or preferences.

The aerodynamic device assembly 120 of example embodiments may alternatively include a plurality of instances of the aerodynamic component 122. In such cases, individual instances of the aerodynamic component 122 may be either individually or collectively (all together or in smaller groups), be dynamically controlled. The “dynamic” nature of the aerodynamic device assembly 120 refers to the fact that components thereof are enabled to be dynamically repositioned responsive to real time conditions and status information to actively enhance the performance of the vehicle 110, which in many cases may relate to the removal of heat from a heat source (e.g., the heat generating component 112).

In an example embodiment, the aerodynamic component control system 100 may include a repositioning assembly (e.g., component actuator 130), which may be provided as part of the aerodynamic component control system 100 in order to reposition or move the aerodynamic device assembly 120 (and one or more instances of the aerodynamic component 122) automatically based on heat generation levels (e.g., temperature) associated with heat generated by the heat generating component 112. Although example embodiments include the automatic response to temperature levels generated, in some cases, the component actuator 130 may also be actuated under the control of a controller 140 (or control module) of the aerodynamic component control system 100. In these example cases, the controller 140 may be part of a vehicle dynamic module (VDM) or other control system of the vehicle 110 that is configured to perform other tasks related or not related to aerodynamic control or performance management. However, the controller 140 could be a dedicated or standalone controller in some cases. The operator (or driver) may disable or enable operation of the component actuator 130 by the controller 140 by using a user interface 132. For example, in one or more modes, the component actuator 130 may be disabled from control by the controller 140, and may instead only operate responsive to heat and temperature levels generated by the heat generating component 112. In one or more other modes, the component actuator 130 may be enabled to move under control of the controller 140 as an override or augmentation to the positioning otherwise determined by the automatic response to heat and temperature levels. The user interface 132 may be internal or external relative to the vehicle 110. Thus, for example, when internal, the user interface 132 may include switches, levers, buttons, a mouse, touch screen display, or any other suitable human machine interface (HMI). Also as examples, when external, the user interface 132 may be an external control console, a smart phone, or other interface component that can wirelessly communicate with the vehicle 110.

In an example embodiment, the controller 140 may receive information that is used to determine vehicle status (or environmental conditions) and vehicle location from or associated with various components or subassemblies 150 of the vehicle 110. Additionally or alternatively, various sensors that may be operably coupled to the components or subassemblies 150 may be included, and may provide input to the controller 140 that is used in determining vehicle status. Such sensors may be part of a sensor network 160 and sensors of the sensor network 160 may be operably coupled to the controller 140 (and/or the components or subassemblies 150) via a vehicle communication bus (e.g., a controller area network (CAN) bus) 170.

The components or subassemblies 150 may include, for example, a brake assembly and/or a wheel assembly of the vehicle 110. Sensors associated with the brake assembly may provide inputs such as temperature, brake pedal position, or brake pressure, to the controller 140. Sensors associated with the wheel assembly may provide information about component temperature, vehicle speed, wheel angle, etc. Other sensors of the sensor network 160 that may be operably coupled to the brake assembly, the wheel assembly or other parts of the vehicle 110 may provide information relating to brake torque, brake torque rate, vehicle speed (and rate of change thereof), individual wheel speeds/angles, etc. Other examples of the components or subassemblies 150 and/or corresponding sensors of the sensor network 160 may provide information relating to pitch, yaw, pitch rate, yaw rate, lateral G force, throttle position, selector button positions associated with chassis and/or vehicle control selections, etc. Thus, for example, the sensors may include an inclinometer, gyroscope, accelerometer, and/or the like. In some cases, the sensor network 160 may further include sensors for detecting weather conditions, road conditions or the like. For example, moisture sensors and temperature sensors may detect wet or icy roads.

Road conditions can also be determined using cameras, microphones, rain sensors, and/or the like in some cases. Thus, for example, the sensor network 160 may also include one or more cameras that operate in the visible light spectrum, infrared cameras, Lidar, and/or the like to detect debris or other obstacles or road conditions. In some cases, however, the cameras may also detect location or position relative to a particular characteristic of the road ahead. For example, the cameras may detect a turn or a straightaway. Moreover, the cameras may detect a magnitude of the turn or length of the straightaway to, for example, control the aerodynamic component positioning based on temperature, and/or other road conditions, which may be determined and controlled by the controller 140.

Accordingly, for example, the controller 140 may be able to receive numerous different parameters, indications and other information that may be related to or indicative of different situations or conditions associated with vehicle status. The controller 140 may also receive information indicative of vehicle location. The controller 140 may then be configured to use the information received defining vehicle status and/or location in association with the execution of one or more control algorithms that may be used to provide instructions to the component actuator 130 in order to control a state (or positions) of the aerodynamic component 122 or devices of the aerodynamic device assembly 120.

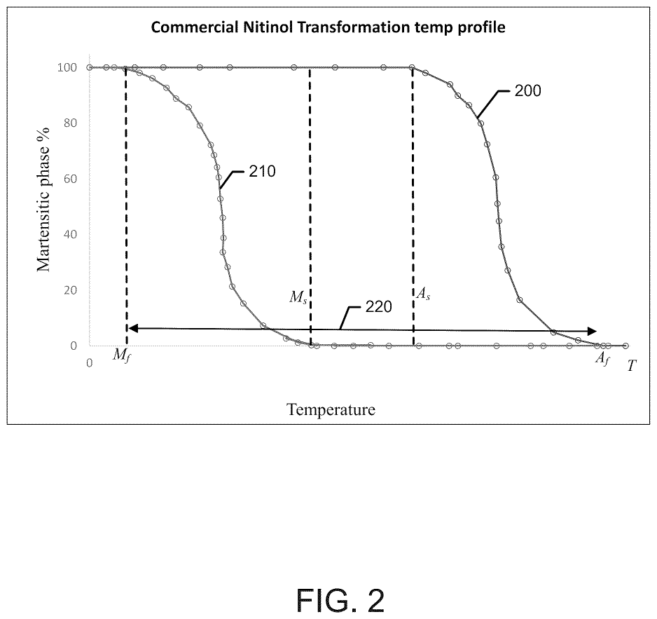

As noted above, the component actuator 130 may be actuated without or independent of the controller 140 in some cases. In this regard, for example, the component actuator 130 may be configured to respond directly to changes in temperature of the heat generating component 112 completely independent of any temperature sensor of the sensor network 160. Instead, the component actuator 130 may have an SMA portion 180 that passively experiences and automatically reacts to the heat generated by the heat generating component 112. The SMA portion 180 may experience a transformation when heated that changes its shape. When cooled, the SMA portion 180 may return to the same shape it had prior to the heating. In particular, phase transformations between austenite and martensite phases may occur based on temperature as shown in FIG. 2. In the example of FIG. 2, a plot is shown for commercially available Nitinol, which is one example of a SMA material that may be used for the SMA portion 180.

As shown in FIG. 2, the SMA may start out at 100% martensitic phase and, as heating occurs along line 200, a phase transformation to austenitic phase begins at temperature Aₛ. The percentage martensitic phase begins to drop after temperature Aₛ until at A_{f}, at which point, the SMA is 0% martensitic (and 100% austenitic). When cooling begins, the temperature profile proceeds along line 210 until temperature Mₛ is reached, at which point the austenitic phase begins to transition back into the austenitic phase. By the time temperature M_{f} is reached, the SMA is fully transitioned back to the martensitic phase. The zone between M_{f} and A_{f} may be considered to be a transition region 220, or transition zone, since at opposing ends thereof, the SMA material is fully transitioned between its martensitic and austenitic phases.

Notably, it is possible to select or otherwise engineer SMA having activation temperatures (and the transition region 220) at desired values. In this regard, for example, given that engine temperatures for an ICE engine may cause under-hood temperatures in the range of 70-93° C., the temperature Aₛ may be selected to be in a range between 50-60° C., the temperature A_{f} may be selected to be in a range between 70-95° C., the temperature Mₛ may be selected to be in a range between 25-40° C., and the temperature M_{f} may be selected to be in a range between 5-15° C. These transitions effectively cause the SMA portion 180 to be in one state at ambient temperatures, and then transition to another state when the engine reaches its normal (hot) operating temperature.

In an example embodiment, the SMA portion 180 may be bent with force, and deformed at low temperature (e.g., in the martensitic phase). As temperature increases, and passes through the transition region 220, the SMA portion 180 may return to its original (i.e., not deformed) shape. The transition in temperature may therefore directly cause a corresponding transition in shape of the SMA portion 180, and the transition in shape of the SMA portion 180 may carry the aerodynamic component 122 (or a portion thereof) to another location or position, thereby effectively repositioning the aerodynamic component 122. For a vent hood louver, as one example, the louver may be closed at ambient or cool temperatures, and may open up when the engine is operating and hot. When the vehicle 110 is shutdown or turned off, and the engine cools, the louver may return to the closed position. The temperature at which the change in shape of the SMA portion 180 occurs may be referred to as an activation temperature.

Notably, for performance (e.g., racing) vehicles, a rain tray is typically required in order to keep rain off engine components when the hood vent louvers are open. However, if rain falls and cools the SMA portion 180, the cooling may cause automatic closure of the vent hood louver, and therefore there may be no need for inclusion of the rain tray. Example embodiments may therefore completely obviate the need for a rain tray, which would not only increase efficiency by reducing part count, but since those rain trays are typically manually installed when not racing and removed when racing, a time consuming and complicated process may also be eliminated, which may dramatically enhance customer satisfaction.

It should also be noted that material properties can be selected to ensure that the transition region 220 falls over any desired range of temperatures that might work best for a given application. In this regard, for example, temperature ranges for operation may be different in different contexts, such as battery, braking, fluid coolant, or other contexts. Regardless of context, the placement of the SMA portion 180 relative to the heat source (e.g., the heat generating component 112) and the corresponding selection of the materials of the SMA portion 180 may be controlled to achieve heat extraction that is strategically performed at desired temperatures. Moreover, given the ability to select different activation temperatures for the SMA portion 180, the further possibility exists to select different activation temperatures for different SMA portions of aerodynamic components in different regions. Thus, for example, a cascading effect of aerodynamic component actuations may be achieved, if desired. Alternatively, where temperatures are different at different locations (e.g., based on distance from the heat generating component 112, intervening structures, and/or other factors that may impact temperature), the use of different activation temperatures may be used to even out activations, or cause activations to occur at the same time (or nearly the same time) even though temperatures are different.

In many applications, the SMA portion 180 may be configured to generate a movement that may define a stroke length of at least about 10 mm. In this regard, for example, the SMA portion 180 may be connected at or near one end to a vehicle substrate (e.g., a portion of the vehicle body, chassis, or another component of the vehicle 110), and may be connected at or near the other end to the aerodynamic component 122 (or another structure connected thereto). The end connected to the vehicle substrate may be fixed, and the other end may be movable when the SMA portion 180 changes shape responsive to temperature change. The change in shape may carry the aerodynamic component 122 (or other structure connected thereto) over a distance of about 10 mm. Moreover, the force application (or actuation force) that can be achieved may be, for example, greater than 40 N (or about 9 lbf). The timing involved is also very fast. For example, full stroke change can be achieved in about 400 ms in many cases. In addition to being fast, the SMA portion 180 may alter position with virtually no sound generation at all (at least none emanating from the SMA portion 180 itself). Accordingly, weight, space and other efficiencies may be achieved by, for example, removing motors or other actuators and replacing them with the component actuator 130, which includes the SMA portion 180.

As can be appreciated from the descriptions above, example embodiments may provide for automatic operation of the aerodynamic component 122 based on temperature via employment of the SMA portion 180. As mentioned above, the controller 140 may be used to override the automatic operation of the aerodynamic component 122 or otherwise change the position of the aerodynamic component 122 from that which temperature would otherwise normally dictate. The controller 140 may do this by simply providing a signal that directly actuates the component actuator 130. However, in other cases, the controller 140 may actually provide an electrical signal to a heating element disposed proximate to the SMA portion 180. Thus, the override that the controller 140 can provide may actually also be provided through heating means, albeit through heat purposely provided under control of the controller 140.

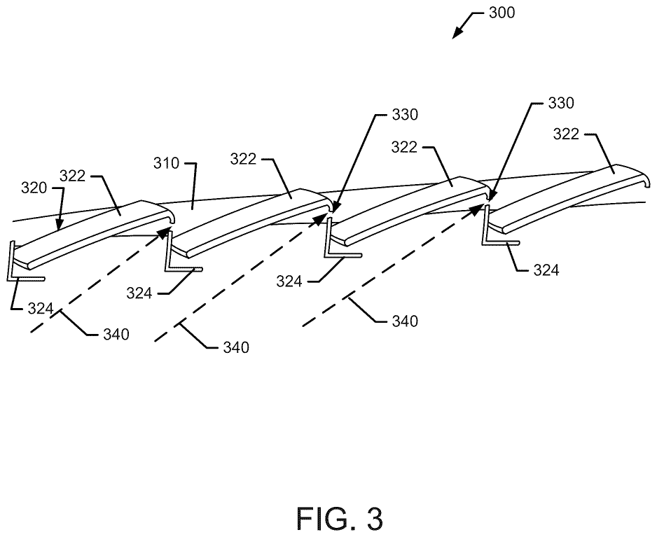

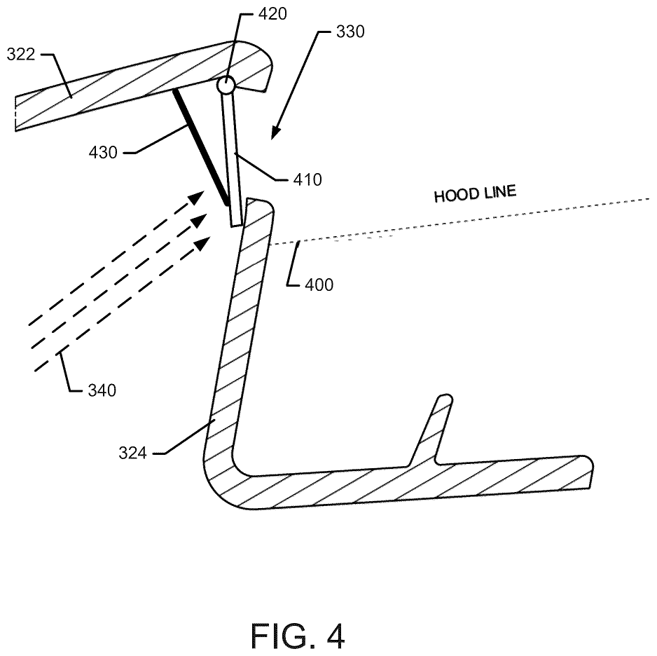

Dependent upon the physical arrangement of the components involved and the potential for additional usage of mechanical linkages, the aerodynamic component 122 may end up actually moving or rotating, and the movement may be more than 10 mm. FIGS. 3-8 illustrate some examples of physical arrangements that may be employed in accordance with an example embodiment. In this regard, FIG. 3 illustrates a perspective view of a cross section taken through a portion of hood of a vehicle having a hood vent assembly 300. The section cut is taken along a line parallel to a longitudinal centerline of the vehicle and its hood. The hood includes a hood periphery 310 that extends around a plurality of louvers 320 (or vents) formed at or near a central portion of the hood (e.g., enclosed by the hood periphery 310). The louvers 320 may be formed to extend transversely across the central portion of the hood between opposing sides of the hood periphery 310. In some cases, the louvers 320 may be formed from a slat portion 322 and a base portion 324. An air passage 330 may be formed between the slat portion 322 of one individual instance of the louvers 320 and the base portion 324 of an adjacent instance of the louvers 320. As shown in FIG. 3, the air passage 330 may, when open or unblocked, permit an airflow 340 under the hood (and therefore proximate to the engine, which is an example of the heat generating component 112 in this scenario) to remove heat from the area around the engine. The alternate blocking or unblocking of the air passage 330 may be accomplished in different ways, some examples of which are shown in FIGS. 4-8.

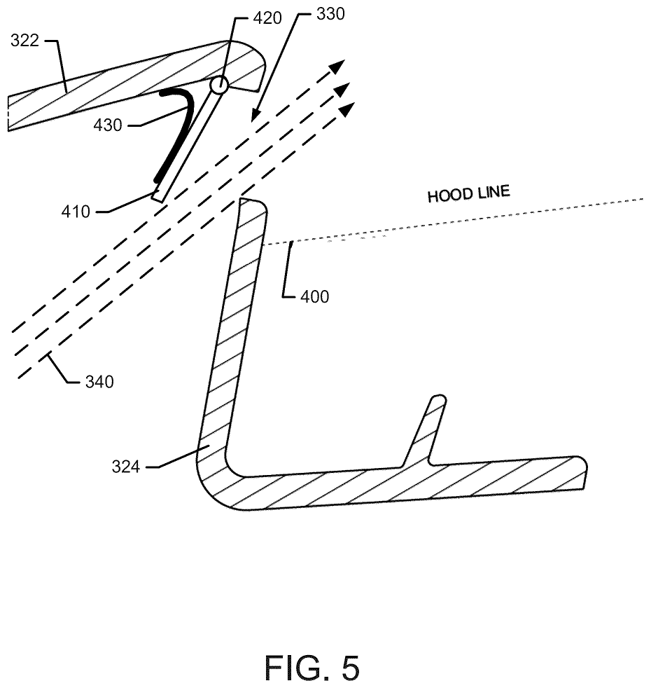

Turning to FIGS. 4 and 5, a close up view of the air passage 330 is shown, alone with a reference line 400, which illustrates a line at which the elevation of the hood periphery 310 of FIG. 3 relative to the base portion 324. FIGS. 4 and 5 also show a flap 410, which may be provided as an example of the aerodynamic component 122 of FIG. 1 to alternately be repositioned with respect to the air passage 330. In this regard, the flap 410 is shown in a closed position in FIG. 4 and in an open position in FIG. 5. The flap 410 may be formed as a soft shot rubber flap that is cantilevered with respect to an underside of the slat portion 322. However, other relatively light, but otherwise rigid materials may alternatively be used to form the flap 410.

The flap 410 may be operably coupled to the underside of the slat portion 322 at a pivot point 420 about which the flap 410 may pivot to transition between the open and closed positions. The pivot point 420 may, in some cases, simply be a point at or from which the flap 410 bends when transitioning between the open and closed positions. However, in other cases, the pivot point 420 may be formed by a hinge or other pivotable structure.

In the example of FIGS. 4 and 5, actuator 430 may be an example of the component actuator 130 of FIG. 1. In this regard, all or a portion of the actuator 430 may include the SMA portion 180 shown in the example of FIG. 1. The actuator 430 may be operably coupled at one end thereof to the underside of the slat portion 322 (which may be an example of a vehicle substrate to which the component actuator 130 of FIG. 1 is attached), and operably coupled at an opposite end thereof to a portion of the flap 410 that is near a distal end thereof (relative to the pivot point 420). Actuator 430 may therefore have a rest position (or cold position), which is shown in FIG. 4, in which the flap 410 contacts the base portion 324 of an adjacent louver 320 (see FIG. 3). The rest or cold position of the actuator 430 corresponds to a closed state in which airflow through the air passage 330 is prevented (or inhibited), which will be the natural state of the actuator 430 when the engine is not running, or at least temperatures around the engine are not sufficient to trigger actuation of the actuator 430.

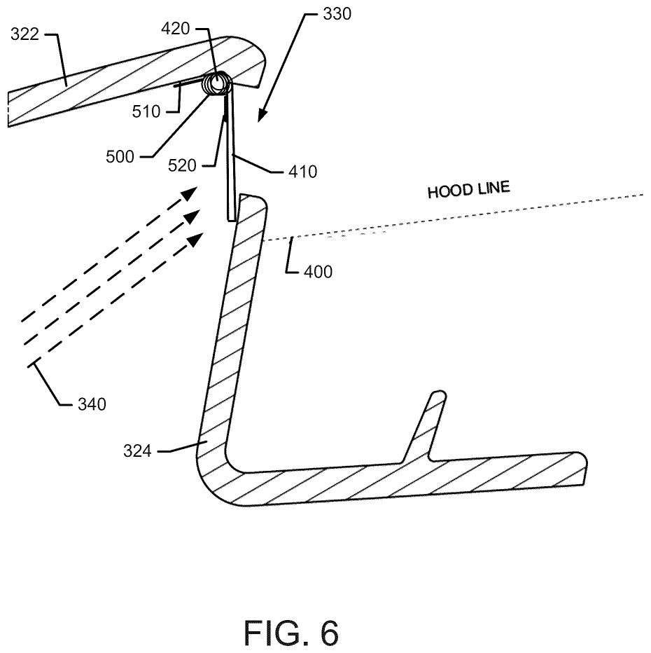

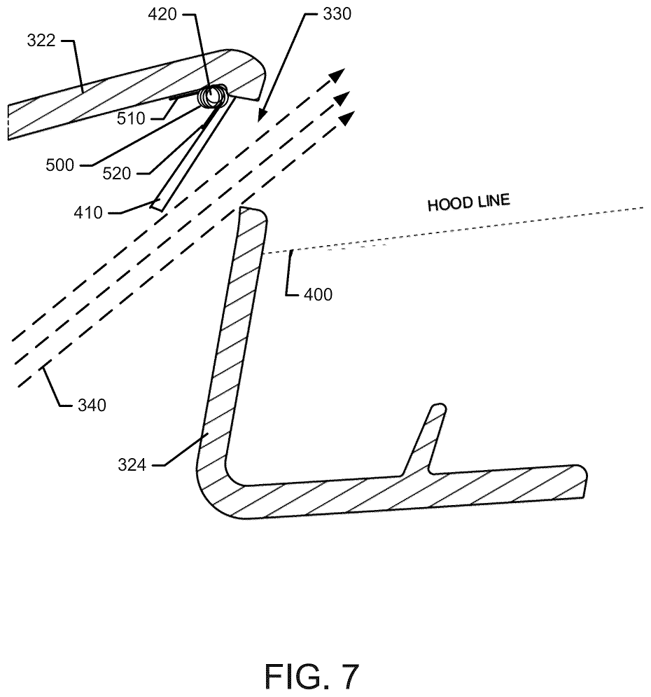

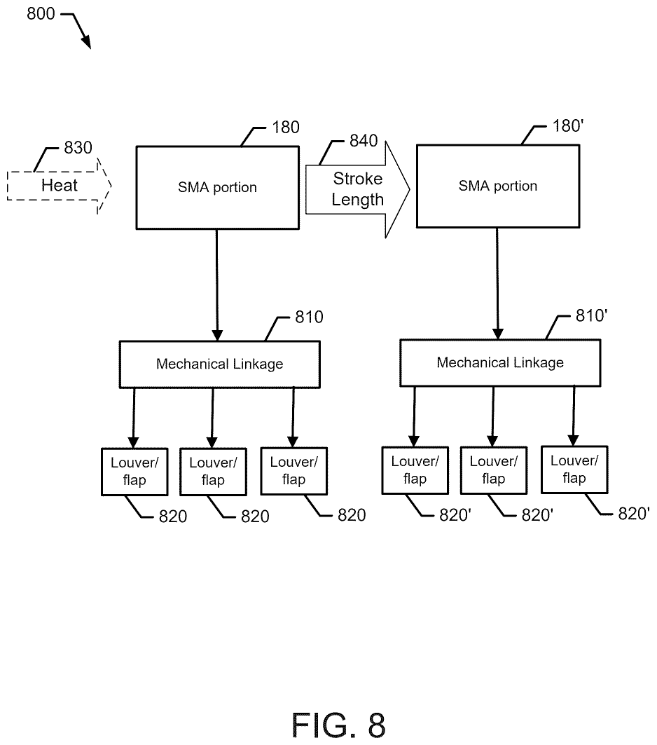

The actuator 430 may also have a deflected position (or hot position), which is shown in FIG. 5, in which the flap 410 is deflected away from the base portion 324. In particular, once the activation temperature is reached, the actuator 430 may bend to the deflected or hot position shown in FIG. 5, and carry the flap 410 along with it, thereby repositioning the flap 410. The deflected or hot position of the actuator 430 may correspond to an open state in which airflow through the air passage 330 is permitted or relatively uninhibited by virtue of the repositioning of the flap 410. Accordingly, the deflected or hot position of the actuator 430 may be the state of the actuator 430 when the engine is running, or at least temperatures around the engine are sufficient to trigger actuation of the actuator 430 (e.g., due to temperature exceeding the activation temperature of the SMA portion 180).

Whereas the examples of FIGS. 4 and 5 may be understood to define an actuation technique involving providing an operable cantilever on each individual vent that is operably coupled to an SMA actuator, other approaches are also possible. In this regard, for example, FIGS. 6 and 7 illustrate the provision of a rotation point that is rotated about based on the use of a torsion spring or coil torsion spring that employs SMA actuation. Meanwhile, FIG. 8 illustrates an embodiment in which a mechanical linkage is used to actuate multiple vents simultaneously.

Turning first to FIGS. 6 and 7, the same general structure of the flap 410 and pivot point 420 described above may apply to the context of the air passage 330, base portion 324 and slat portion 322. However, the actuator 430 may be replaced instead by actuator 500, which may take the form of a coil spring or torsion spring that is disposed about the pivot point 420 and has a first end 510 operably coupled to an underside of the slat portion 322 and a second end 520 operably coupled to the flap 410 (at or near the proximal end thereof (e.g., close to the pivot point 420)).

In the example of FIGS. 6 and 7, actuator 500 may be an example of the component actuator 130 of FIG. 1. In this regard, all or a portion of the actuator 500 may include the SMA portion 180 shown in the example of FIG. 1. The actuator 500 may have a rest position (or cold position), which is shown in FIG. 6, in which the flap 410 contacts the base portion 324. The rest or cold position of the actuator 500 corresponds to a closed state in which airflow through the air passage 330 is prevented (or inhibited), which will be the natural state of the actuator 500 when the engine is not running, or at least temperatures around the engine are not sufficient to trigger actuation of the actuator 500.

The actuator 500 may also have a deflected position (or hot position), which is shown in FIG. 7, in which the flap 410 is deflected away from the base portion 324. In particular, once the activation temperature is reached, the actuator 500 may bend to the deflected or hot position shown in FIG. 7. The first and second ends 510 and 510 of the actuator 500 may be drawn closer together by the deflection, and may carry the flap 410 to reposition the flap 410 to the deflected or hot position. The deflected or hot position of the actuator 500 may correspond to an open state in which airflow through the air passage 330 is permitted or relatively uninhibited by virtue of the repositioning of the flap 410. Accordingly, the deflected or hot position of the actuator 500 may be the state of the actuator 500 when the engine is running, or at least temperatures around the engine are sufficient to trigger actuation of the actuator 500 (e.g., due to temperature exceeding the activation temperature of the SMA portion 180).

Turning to FIG. 8, which demonstrates another example embodiment in block diagram form, an actuation assembly 800 for multiple vents is shown. The actuation assembly 800 may employ a mechanical linkage 810 that extends between multiple movable louvers or flaps (e.g., louver/flap 820) to control all of the instances of the louver/flap 820 together simultaneously in response to the activation temperature of the SMA portion 180 being reached. In particular, when the SMA portion 180 is exposed to heat 830 that rises a level at which the activation temperature of the SMA portion 180 is reached, the SMA portion 180 may deflect or change shape. To the extent the SMA portion 180 is embodied as a linear actuator, the SMA portion 180 may physically move a distance defined by stroke length 840 to a deflected SMA portion position 180′. The mechanical linkage 810, which is operably coupled to the SMA portion 180 may correspondingly be carried or moved to a deflected mechanical linkage position 810′, and the instances of the louver/flap 820 may each also be carried to a deflected louver/flap position 820′. The linear actuator may carry the mechanical linkage 810 a distance defined by the stroke length 840, and also translate all instances of the louver/flap 820 by the same physical distance. However, further mechanical advantage may be employed by the mechanical linkage 810 to employ lever action and pivoting action to achieve even larger distances of movement at the louver/flap 820 than the stroke length 840 in some cases.

Notably, although FIG. 8 shows three instances of the louver/flap 820 being grouped for simultaneous movement by one instance of the SMA portion 180 via the mechanical linkage 810, the mechanical linkage 810 could alternatively reposition as few as two instances of the louver/flap 820 together or several more additional instances of the louver/flap 820 simultaneously. The activation force (e.g., about 40 N for Nitinol, but different for other SMA materials), and the weight and resistance to movement of the louver/flap 820 (or other aerodynamic devices) will ultimately determine the limits to the numbers of aerodynamic devices that can be operated by a single SMA portion 180 and corresponding instance of the mechanical linkage 810.

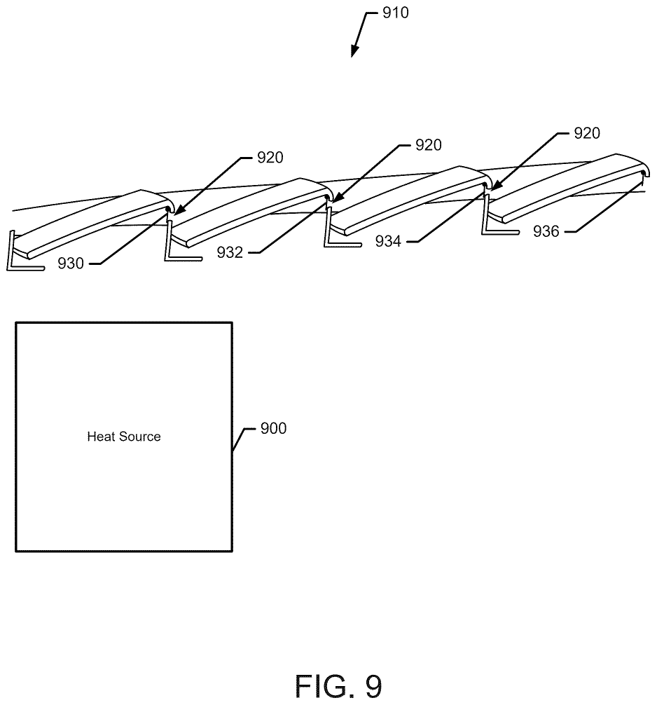

In addition to selecting different materials (e.g., Nitinol or other materials) for the SMA portion 180, properties of any selected material can also be modified in some cases to fine tune activation temperatures for different instances of the SMA portion 180, and therefore fine tune different activation temperatures for different actuators. Thus, for example, activation temperatures for actuators in one region may be different than activation temperatures for actuators in another region. This may enable at least two different, but unique approaches to be implemented. For example, one approach may be to select or tune actuators with different activation temperatures to be activated at about the same time even though they are exposed to different temperatures. Another approach may be to select different activation temperatures for different regions in order to provide varying (but strategically controllable) heat rejection capacity. Both of these options will be described in reference to FIG. 9, which shows a heat source 900 that could be an engine, a battery, an exhaust component, a braking system component, or any other vehicle component or assembly that generates heat during operation of the vehicle 110.

The example of FIG. 9 includes a louver assembly 910 where air passages 920 are selectively opened or closed based on a position of flaps that either block the air passages 920 (when not actuated or activated) or are deflected to be clear of the air passages 920 when actuated or activated. The flaps include a first flap 930, a second flap 932, a third flap 934, and a fourth flap 936. The first, second, third and fourth flaps 930, 932, 934 and 936 may be only some of many more flaps that also exist, or fewer flaps may be provided in other examples. However, it should be understood that the flaps are merely one example implementation of the aerodynamic component 122, and other example structures for alternative aerodynamic component implementations may be employed in other cases.

For the example implementation where tuning of activation temperatures is made to attempt to synchronize activations of the first, second, third and fourth flaps 930, 932, 934 and 936, it should first be appreciated that the first flap 930 is closest in proximity to the heat source 900, and therefore may be expected to be exposed to a higher temperature than the other flaps. Moreover, the fourth flap 936 is farthest away from the heat source 900 and therefore may be expected to experience lower temperatures than the other flaps. A reduction in temperature in steps may occur from the first flap 930 to the second flap 932, and then on to the third flap 934 and fourth flap 936. Accordingly, an activation temperature of the first flap 930 may be set to be higher than that of the second flap 932. The second flap 932 may have a higher activation temperature than the third flap 934, and the third flap 934 may have a higher activation temperature than the fourth flap 936. With tuning to match the difference in activation temperatures to the normal differences in temperature exposure that occur based on proximity to the heat source 900, it may be possible to get all of the first, second, third and fourth flaps 930, 932, 934 and 936 to actuate at nearly the same time, even though the temperatures experienced at each location are slightly different. In particular, activation temperature may be selected to decrease as distance from the heat source 900 increases.

Turning to the other alternative of varying heat rejection capacity, an example use case to consider may be one in which the heat source 900 is a battery and the flaps open to alloy heat removal from the battery. In some cases, a first set of flaps (e.g., the first and second flap 930 and 932) may be selected to have a first activation temperature that is lower, and that is achieved during normal operation (e.g., charging or discharging) when heat is generated by the battery. However, if thermal runaway or otherwise excessive battery heating is experienced, a second set of flaps (e.g., the third and fourth flaps 934 and 936) may be selected to have a second activation temperature that is higher than the first activation temperature. When the second activation temperature is reached, the second set of flaps may open to provide additional heat rejection capacity to prevent thermal runaway of the battery.

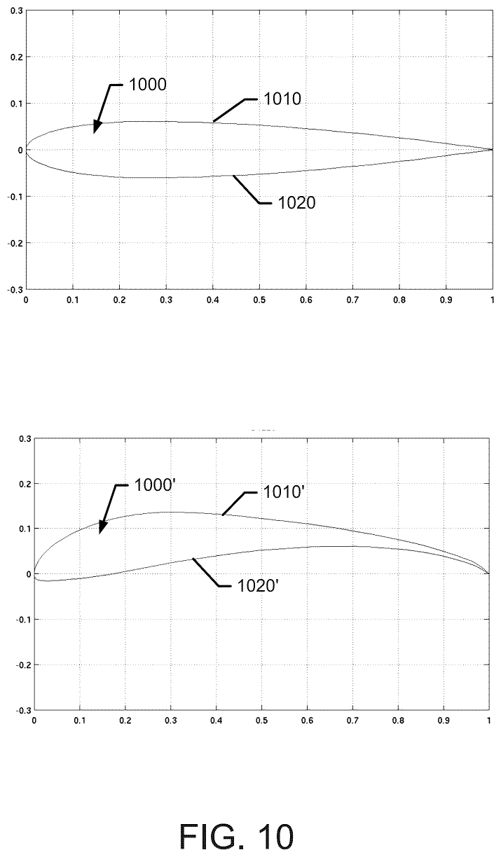

In the examples described above, it is generally assumed that the SMA material deforms to cause a repositioning that either deploys (when actuated) or retracts (when not actuated) an aerodynamic component to control heat removal or apply active aerodynamic control based on temperature. However, rather than just being used as a trigger mechanism, the deformations achievable by SMA material may alternatively be used to change the shape of an aerodynamic component or airfoil as well. FIG. 10 illustrates a cross section view of an airfoil 1000 having a first rib 1010 and a second rib 1020 that may form top and bottom portions of the airfoil 1000, and which may have other ribs both closer to and farther from the viewer along with a skin or sheathing material over the ribs to form the airfoil 1000. The skin or sheathing material may be flexible.

By employing SMA material in the first and second ribs 1010 and 1020, an entire shape of the airfoil 1000 may be changed when the SMA material is activated. For example, when temperature reaches the activation temperature of the SMA material, a deformation of the ribs may occur so that a deformed first rib 1010′ and a deformed second rib 1020′ combine to form a different deformed airfoil shape 1000′. Airflow over the deformed airfoil shape 1000′ may be different than that of the airfoil 1000, and various desirable changes in lift, drag or other aerodynamic properties/forces may be achieved through this type of control.

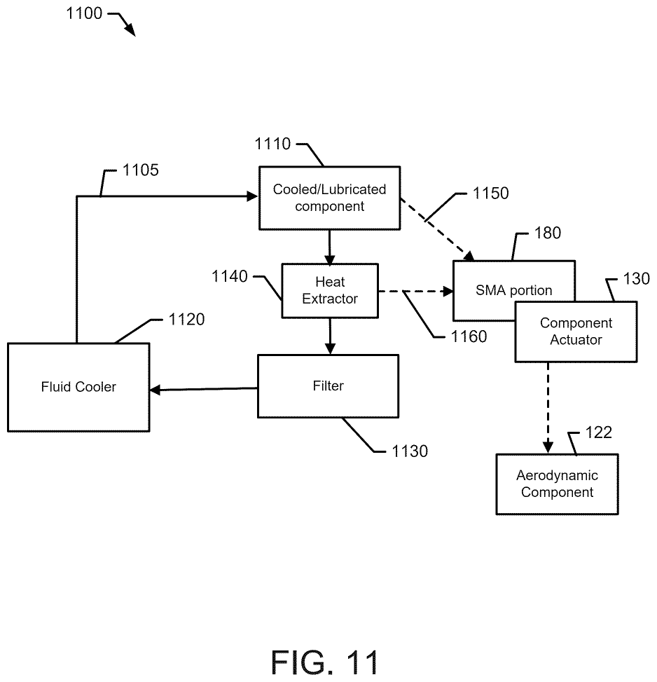

In the examples above, it has generally been the case that convection is the heat transfer means by which the component actuator 130 (and consequently also the SMA portion 180) are exposed to heat. Whereas convection (and convective airflow) are clearly useful examples for how some example embodiments may work, they are not the only examples. Conductive and radiative heat transfer means may also be employed in alternative example embodiments. FIG. 11 illustrates one example in which conductive heat transfer is employed.

Referring now to FIG. 11, a fluid system 1100 is shown as an example of a heat generating system from which heat may be drawn to actuate remote (relative to the heat source) aerodynamic components. The fluid system 1100 may be part of a brake assembly, a coolant assembly, a lubrication assembly, or any other suitable fluid system of the vehicle 110 that generates enough heat to reach the activation temperature of the component actuator 130. Solid connecting lines in FIG. 11 define a fluid circuit 1105 inside which a cooling or lubricating fluid may flow. Thus, for example, a cooled or lubricated component 1110 may effectively be the heat generating component within the fluid circuit 1105. Heat generated by an engine, battery, exhaust component, braking component, and/or the like may be imparted on or otherwise communicated to the fluid inside the fluid circuit 1105.

Cold fluid (e.g., with heat having been removed by a form of heat exchange) leaves a fluid cooler 1120 and is provided to cool or lubricate the cooled or lubricated component 1110. That cold fluid is heated, and then relatively hot fluid leaves the cooled or lubricated component 1110 and is provided to a filter 1130 before return to the fluid cooler 1120. A pump (not shown) may also be provided to impart motive force on the fluid to keep it moving through the fluid circuit 1105. The hot fluid is typically hottest immediately after it leaves the cooled or lubricated component 1110. Thus, to use the heat generated by the fluid system 1100 as a trigger mechanism for automatic control of the aerodynamic component 122, a heat extractor 1140 may be disposed to act as a heat sink relative to the hot fluid leaving the cooled or lubricated component 1110. The heat extractor 1140 may be in direct or physical contact with the hot fluid (e.g., inside a pipe of the fluid circuit 1105), or may be indirectly in contact with the hot fluid (e.g., attached to an outer surface of the pipe of the fluid circuit 1105). Heat transferred from the hot fluid to the heat extractor 1140 may then be communicated directly or indirectly to the SMA portion 180 of the component actuator 130 to actuate the aerodynamic component 122 when the activation temperature is reached. This may deploy the aerodynamic component 122. When the fluid cools (e.g., due to non-operation, or reduced heating, the aerodynamic component 122 may be retracted automatically as the cooling fluid passes through the transition zone on the cooling path, as noted above in reference to FIG. 2.

In an example embodiment, the SMA portion 180 may be attached directly to the cooled or lubricated component 1110 as shown by arrow 1150. However, if the aerodynamic component 122 is farther away from the cooled or lubricated component 1110, it may be desirable to provide a heat conduit 1160 that transfers heat from the heat extractor 1140 either directly to the SMA portion 180 (for conductive heat transfer) or to a location close to the SMA portion 180 (for convective heat transfer). The heat conduit 1160 may be a solid metal portion that transfers heat, or may itself also include a fluid that can transfer heat. In either case, the heat conduit 1160 may take heat generated at one location and transfer it to another location at which it can perform the useful task of actuating the aerodynamic component 122. Particularly in examples in which the aerodynamic component 122 is an airfoil, the aerodynamic component 122 may not be immediately or directly exposed to heat. Thus, the example of FIG. 11 may provide the opportunity to use remote heat (e.g., brake heat or engine block heat) to trigger activation of a remote aerodynamic component (e.g., rear spoiler, splitter wicker, dive plane, gurney flap, etc.).

Accordingly, an airflow control system for a vehicle may be provided. The airflow control system may include an airflow component configured to be repositioned to control a flow of air generated by motion of the vehicle, a vehicle substrate, and a component actuator comprising a shape memory alloy portion. The component actuator may be operably coupled to the vehicle substrate and the airflow control component to actuate automatically to reposition the airflow control component responsive to a temperature of the shape memory alloy portion reaching an activation temperature of a shape memory alloy material forming the shape memory alloy portion. The shape memory alloy portion may be passively exposed to temperature changes of a heat generating component of the vehicle, the temperature changes of the heat generating component of the vehicle being based on an operating state of the vehicle.

The system of some embodiments may include additional features, modifications, augmentations and/or the like to achieve further objectives or enhance performance of the system. The additional features, modifications, augmentations and/or the like may be added in any combination with each other. Below is a list of various additional features, modifications, and augmentations that can each be added individually or in any combination with each other. For example, the airflow control component may include a flap that alternately permits and blocks passage of air through an air passage. The shape memory alloy portion may be operably coupled to the airflow control component at a first end of the shape memory alloy portion and operably coupled to the vehicle substrate at a second end of the shape memory alloy portion. The shape memory alloy portion may have a rest state in which a distal end of the flap is in a first position blocking the passage of air through the air passage, and an activated state in which the distal end of the flap rotates about a pivot point proximate the vehicle substrate to permit the passage of air through the air passage. In an example embodiment, the second end of the shape memory alloy portion may be attached to the flap proximate to the distal end of the flap, and the shape memory alloy portion may bend responsive to exceeding the activation temperature to carry the distal end of the flap while transferring to the activated state. In some examples, the second end of the shape memory alloy portion may be attached to the flap at or near a proximal end of the flap, and the shape memory alloy portion may form a coil spring about the pivot point to drawn the first and second ends of the shape memory alloy portion closer together to rotate the flap as the shape memory alloy bends responsive to exceeding the activation temperature while transferring to the activated state. In an example embodiment, the shape memory alloy portion comprises a linear actuator that moves a mechanical linkage over a stroke length of the shape memory alloy portion, and the mechanical linkage may be operably coupled to the airflow control component to move the airflow control component by a distance at least as long as the stroke length. In some examples, the mechanical linkage may be operably coupled to a plurality of instances of the airflow control components to change a state of each of the plurality of instances of the airflow control components simultaneously responsive to exceeding the activation temperature. In an example embodiment, the heat generating component of the vehicle may include a battery, engine, motor, braking component, or exhaust component, and the shape memory alloy portion may receive heat transfer directly or indirectly from the heat generating component to actuate to increase heat removal capacity from the heat generating component of the vehicle. In some examples, the shape memory alloy portion may receive heat from the heat generating component by convective heat transfer. In an example embodiment, the shape memory alloy portion may receive heat from the heat generating component by conductive heat transfer. In some examples, the system may further include a heat extractor disposed proximate to the heat generating component, and a heat conduit operably coupled to the heat extractor and the shape memory alloy portion. The shape memory alloy may be located remotely relative to the heat generating component. In an example embodiment, the system may further include a plurality of airflow control components and a corresponding plurality of component actuators, and, respective shape memory alloy portions of the corresponding plurality of component actuators may each have a different activation temperature. In some examples, the different activation temperature of the respective shape memory alloy portions may define a gradient with respect to activation temperatures to define a consistent actuation time for the plurality of airflow control components by decreasing the activation temperatures as distance from the heat generating component increases. In an example embodiment, the different activation temperature of the respective shape memory alloy portions may define a gradient with respect to activation temperatures to define different actuation times for the plurality of airflow control components as respective different activation temperatures are reached to modify heat removal capacity from the heat generating component. In some examples, a material of the shape memory alloy may be Nitinol. In an example embodiment, the airflow control component may be an airfoil and the shape memory alloy portion may alter shape to correspondingly alter a shape the airfoil responsive to temperature exceeding the activation temperature. In some examples, the airflow control component may include a vent hood, grill shudder, fender vent, battery vent, dive plane, spoiler, gurney flap, or splitter wicker. In an example embodiment, the system may further include a controller configured to provide an override signal to the component actuator to actuate the aerodynamic component without regard to the temperature changes of the heat generating component.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe exemplary embodiments in the context of certain exemplary combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. In cases where advantages, benefits or solutions to issues are described herein, it should be appreciated that such advantages, benefits and/or solutions may be applicable to some example embodiments, but not necessarily all example embodiments. Thus, any advantages, benefits or solutions described herein should not be thought of as being critical, required or essential to all embodiments or to that which is claimed herein. Although specific terms are employed herein, they are used in a generic and descriptive sense only and not for purposes of limitation.

What is claimed:

1. An airflow control system for a vehicle, the system comprising:
an airflow control component configured to be repositioned to control a flow of air generated by motion of the vehicle;
a vehicle substrate; and
a component actuator comprising a shape memory alloy portion, the component actuator being operably coupled to the vehicle substrate and the airflow control component to actuate automatically to reposition the airflow control component responsive to a temperature of the shape memory alloy portion reaching an activation temperature of a shape memory alloy material forming the shape memory alloy portion,
wherein the shape memory alloy portion is passively exposed to temperature changes of a heat generating component of the vehicle, the temperature changes of the heat generating component of the vehicle being based on an operating state of the vehicle.

2. The system of claim 1, wherein the airflow control component comprises a flap that alternately permits and blocks passage of air through an air passage,
wherein the shape memory alloy portion is operably coupled to the airflow control component at a first end of the shape memory alloy portion and operably coupled to the vehicle substrate at a second end of the shape memory alloy portion, and
wherein the shape memory alloy portion has a rest state in which a distal end of the flap is in a first position blocking the passage of air through the air passage, and an activated state in which the distal end of the flap rotates about a pivot point proximate the vehicle substrate to permit the passage of air through the air passage.

3. The system of claim 2, wherein the second end of the shape memory alloy portion is attached to the flap proximate to the distal end of the flap, and
wherein the shape memory alloy portion bends responsive to exceeding the activation temperature to carry the distal end of the flap while transferring to the activated state.

4. The system of claim 2, wherein the second end of the shape memory alloy portion is attached to the flap at or near a proximal end of the flap, and
wherein the shape memory alloy portion forms a coil spring about the pivot point to drawn the first and second ends of the shape memory alloy portion closer together to rotate the flap as the shape memory alloy bends responsive to exceeding the activation temperature while transferring to the activated state.

5. The system of claim 1, wherein the shape memory alloy portion comprises a linear actuator that moves a mechanical linkage over a stroke length of the shape memory alloy portion, and
wherein the mechanical linkage is operably coupled to the airflow control component to move the airflow control component by a distance at least as long as the stroke length.

6. The system of claim 5, wherein the mechanical linkage is operably coupled to a plurality of instances of the airflow control components to change a state of each of the plurality of instances of the airflow control components simultaneously responsive to exceeding the activation temperature.

7. The system of claim 1, wherein the heat generating component of the vehicle comprises a battery, engine, motor, braking component, or exhaust component, and
wherein the shape memory alloy portion receives heat transfer directly or indirectly from the heat generating component to actuate to increase heat removal capacity from the heat generating component of the vehicle.

8. The system of claim 7, wherein the shape memory alloy portion receives heat from the heat generating component by convective heat transfer.

9. The system of claim 7, wherein the shape memory alloy portion receives heat from the heat generating component by conductive heat transfer.

10. The system of claim 9, further comprising a heat extractor disposed proximate to the heat generating component, and a heat conduit operably coupled to the heat extractor and the shape memory alloy portion, and
wherein the shape memory alloy is located remotely relative to the heat generating component.

11. The system of claim 1, further comprising a plurality of airflow control components and a corresponding plurality of component actuators,
wherein respective shape memory alloy portions of the corresponding plurality of component actuators each have a different activation temperature.

12. The system of claim 11, wherein the different activation temperature of the respective shape memory alloy portions defines a gradient with respect to activation temperatures to define a consistent actuation time for the plurality of airflow control components by decreasing the activation temperatures as distance from the heat generating component increases.

13. The system of claim 11, wherein the different activation temperature of the respective shape memory alloy portions defines a gradient with respect to activation temperatures to define different actuation times for the plurality of airflow control components as respective different activation temperatures are reached to modify heat removal capacity from the heat generating component.

14. The system of claim 1, wherein a material of the shape memory alloy is Nitinol.

15. The system of claim 1, wherein the airflow control component is an airfoil and the shape memory alloy portion alters shape to correspondingly alter a shape the airfoil responsive to temperature exceeding the activation temperature.

16. The system of claim 1, wherein the airflow control component comprises a vent hood, grill shudder, fender vent, battery vent, dive plane, spoiler, gurney flap, or splitter wicker.

17. The system of claim 1, further comprising a controller configured to provide an override signal to the component actuator to actuate the airflow control component without regard to the temperature changes of the heat generating component.

18. A component actuator configured to actuate an airflow control component repositionable to control a flow of air generated by motion of a vehicle, the component actuator comprising:
a shape memory alloy portion passively exposed to temperature changes of a heat generating component of the vehicle, the temperature changes of the heat generating component of the vehicle being based on an operating state of the vehicle,
wherein the component actuator is operably coupled to a vehicle substrate and an airflow control component to actuate automatically to reposition the airflow control component responsive to a temperature of the shape memory alloy portion reaching an activation temperature of a shape memory alloy material forming the shape memory alloy portion.

19. The component actuator of claim 18, wherein the heat generating component of the vehicle comprises a battery, engine, motor, braking component, or exhaust component, and
wherein the shape memory alloy portion receives heat transfer directly or indirectly from the heat generating component to actuate to increase heat removal capacity from the heat generating component of the vehicle.

20. The component actuator of claim 18, wherein the shape memory alloy portion is operably coupled to a controller that provides an override signal to the component actuator to actuate the airflow control component without regard to the temperature changes of the heat generating component via input by a user from the controller.
